(19) United States
(12) Patent Application Publication
(10) Pub. No.: US 2014/0133670 A1
(43) Pub. Date: May 15, 2014

(54) HEADPHONE DEVICE

(71) Applicant: POWERTECH INDUSTRIAL CO., LTD., New Taipei City (TW)

(72) Inventors: YU-LUNG LEE, NEW TAIPEI CITY (TW); YU HSUAN CHEN, NEW TAIPEI CITY (TW)

(73) Assignee: POWERTECH INDUSTRIAL CO., LTD., NEW TAIPEI CITY (TW)

(21) Appl. No.: 13/845,214

(22) Filed: Mar. 18, 2013

(30) Foreign Application Priority Data
Nov. 12, 2012 (TW) 101142091

(51) Int. Cl. H04R 1/10

(52) U.S. Cl. CPC H04R 1/1091
USPC 381/74

(57) ABSTRACT

The present invention discloses a headphone device, which is used for communicating with an electronic device and comprises a holder, a headset module, and a display module. The headset module is disposed at least one ends of the holder. The display module is pivoted on the headset module so that the display module can rotate relative to the holder. The display module is selectively overlapped on the holder due to a relative rotation between the display module and the holder. Therefore, the display module can be overlapped on the holder when the user needs not use the display module, and when it is necessary to use the display module, the display module can be rotated to a proper operation position, resulting in an increased flexibility in actual use.

### BACKGROUND OF THE INVENTION

1. Field of the Invention

The present invention relates to a headphone device; in particular, to a headphone device having a display module capable of being selectively superimposed on the holder thereof.

2. Description of Related Art

Recently accompanied with technological advance and mature development of communicational transmission technology, people are more inseparable from smart handheld devices in their daily life; for example, when taking public transportation, more and more passengers would achieve the purpose of learning, entertainment, and talking with other persons by the smart handheld devices.

Although smart handheld device has become thinner, it is not so suitable for some occasions to take out the smart handheld device for operation or talking with other individual. In order to solve above problems, a Bluetooth headset and a multi-functional head-mounted display are developed, thereby achieving a handheld-free effect.

However, when finishing taking with other person or wanting to suspend the operation of the smart handheld device, users, due to a microphone or display screen often still located beside the mouth or eyes and obscuring part of user's line of sight when the users process affairs at hand, dismantle the Bluetooth headset and the multi-functional head-mounted display and do not wear them again until they desire to operate those smart handheld devices, resulting in inconvenience on actual use.

On the other hand, in order to increase the convenience of using the smart handheld device, a designer Mike Enayah has designed an apparatus in which iPhone can be disposed in an empty shell body rotatably connected with the side of an earphone, and the empty shell body can be placed in front of user's eyes. When users want to use their iPhones, they can dispose iPhones in this empty shell body to observe the image of iPhone screen revealing from this empty shell body, and then listen to the voice through earphone thereof. However, as could be perceived by the design thereof, a special design in this apparatus is a headband fixed in the back of user's head to overcome the uncomfortable problem that the weight of iPhone itself causes earphone to lean forward. Besides, said design still has other problems such as too large volume and inconvenience of using (need wearing a headband), so we need to develop a design which allows more convenient using for users.

### SUMMARY OF THE INVENTION

The object of the present invention is to provide a headphone device, wherein a display module thereof is pivoted on the headset module, so that the display module could rotate relative to the holder. Thereby, in no need of using the display module, the display module could be superimposed on the holder, whereas in the need of using the display module, the display module could be rotated to an appropriate position.

In order to achieve the aforementioned objects, according to an embodiment of the present invention, a headphone device is provided for transmitting signals to a electronic device, and this headphone device comprises a holder, a headset module, and a display module. The headset module is disposed on at least one end of the holder, and the display module is pivoted on the headset module to let itself be rotatable relative to the holder, wherein the relative rotation between the display module and the holder enable the display module to be selectively superimposed on the holder.

According to an embodiment of the present invention, the headphone device further comprises a microphone pivoted on the headset module, so that the microphone could rotate with respect to the holder, and when the display module rotates with respect to the holder, it will enable the rotation of the microphone, too.

In summary, the embodiment of the present invention provides a design about a headphone device comprising a display module and a microphone pivoted on the headset module, so that the display module and the microphone could simultaneously or independently be rotated relative to the holder. Thereby, in no need of using the display module and the microphone, they could be superimposed on the holder, whereas in the need of using the display module and the microphone, they could be rotated to an appropriate operation position, resulting in an increased flexibility in actual use greatly.

In order to further the understanding regarding the present invention, the following embodiments are provided along with illustrations to facilitate the disclosure of the present invention.

### BRIEF DESCRIPTION OF THE DRAWINGS

FIG. 1A is a perspective schematic view showing one embodiment of a headphone device according to the present invention;

FIG. 1B is a perspective schematic view showing one embodiment of a display module superimposed on a holder according to the present invention;

FIG. 2A is a perspective schematic view showing another embodiment of a headphone device according to the present invention;

FIG. 2B is a perspective schematic view showing a further embodiment of a display module superimposed on a holder according to the present invention;

FIG. 3A is a perspective schematic view showing a further embodiment of a headphone device according to the present invention;

FIG. 3B is a perspective schematic view showing a further embodiment of a display module superimposed on a holder according to the present invention;

FIG. 4 is a block diagram showing a headphone device according to the present invention;

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

### One Embodiment of a Headphone Device

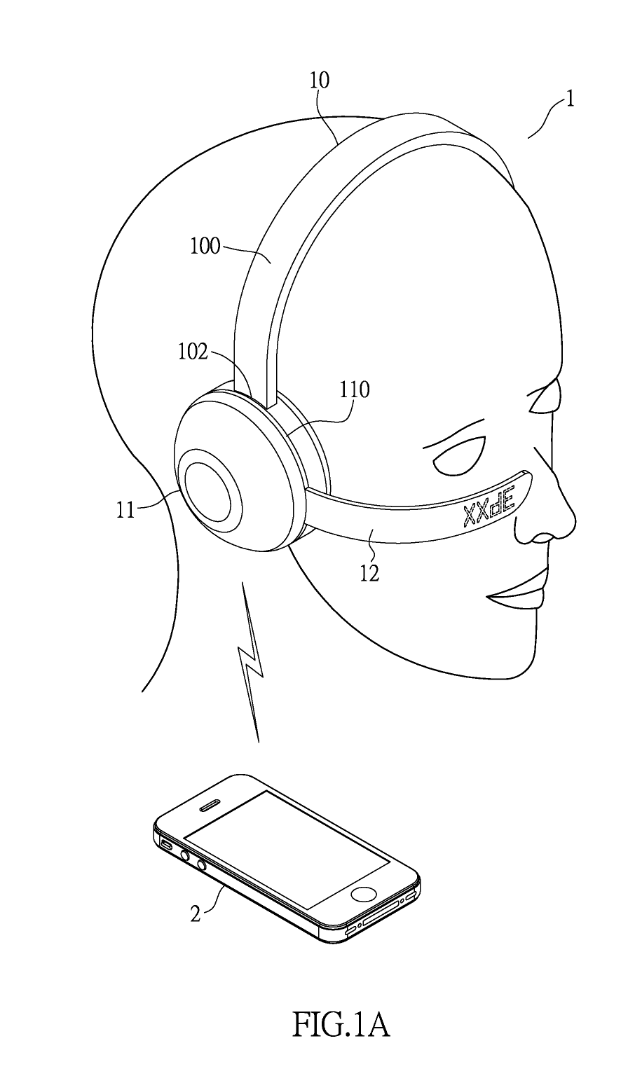

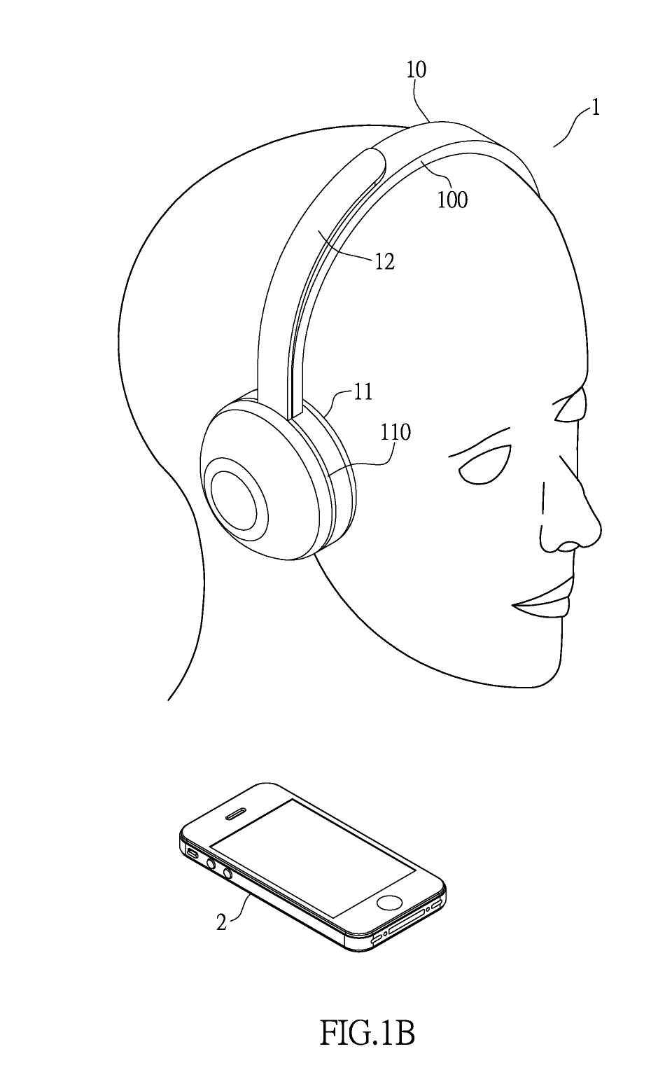

Please refer to FIG. 1A, which shows a perspective schematic view of one embodiment of a headphone device according to the present invention. As shown in FIG. 1A, the headphone device 1 mainly includes a holder 10, a headphone module 11 and a display module 12, and this headphone device 1 is used for signal transfer with the electronic device 2. In general, the electronic device 2 is provided with the function of storing multimedia files such as sound, text, and image information etc, so the electronic device 2 can be a digital audio play device (commonly known as MP3), a digital multimedia play device, a personal digital assistant (PDA), a mobile internet devices (MID), or a smart phone, but the electronic device 2 shall not be limited thereto. As follows is detailed description in terms of each component of headphone device.

The holder 10 is a U-shaped design which can mainly be divided into three parts, including the holder body 100, the connection endpoint 102, and the connection endpoint 104 (not shown in the drawing), respectively. The holder body 100 is used to provide a supporting force by which the holder can abut against the user's head. Connection endpoints 102 and 104 are located at both ends of the holder body 100 for connecting a headset module 11. Generally, the material of the holder 10 can be a flexible substrate such as plastic material, metallic material or alloy material, but the material used is not limited thereto. In practice, the holder body 100 can be a retractable headband design which allows the user to adjust the length of the holder body 100 according to external shape of user's head. In addition, a layer of flocking sponge may be provided on the inner side of the holder body 100 to provide the users with the sense of comfort when they wear it.

The headset module 11 is for playing the audio message of the electronic device 2 and set on at least one end of the holder 10, and the position is not limited thereto in the present invention. In more detail, two headset modules 11 are respectively connected to the connection endpoint 102 and 104 of the holder 10 in the embodiment of the present invention, and in the present invention the mode of connection of the headset module 11 set on the connection endpoints 102 and 104 is not limited. In general, the inner side of the headset module 11 belonging to the headphone device 1 can be set with a layer of flannel earmuffs to provide users with the sense of comfort when they wear it, and thus not only to make the played sound difficult to leak out but also to isolate the interference of the external environment.

The display module 12 is used for displaying the image and text information of the electronic device 2 and pivoted on the headset module 11, so that the display module 12 may be rotated with respect to the holder 10. To more specifics, the display module 12 is pivoted on the headphones module 11 through a rotary element 110 so that the display module 12 may be selectively rotated toward the extending direction of the shell body of the headset module 11.

In practice, the display module 12 can be an organic light emitting diodes (OLED) display, an active matrix organic light emitting diode (AMOLED) display, or thin film transistor liquid crystal display (TFT-LCD), and the using type, size and setting position of the display module 12 is not be limited in the present invention.

In the present invention embodiment, the display module 12 can be also a transparent structure, and when the display module 12 is moved to the front of user's eyes, the user can still see the front scene through the transparent display module 12. Besides, in more designs of this embodiment, information can be shown on this display module 12. The mode of showing information is accomplished by using the liquid crystal on a transparent screen to displays the messages, or by projecting the messages to the transparent screen by means of a projection mode.

An embodiment of forming the display module 12 by a transparent liquid crystal screen is described in detail herein. The border of this transparent liquid screen is provided with at least one white light emitting diode to supply a portion of backlight for the transparent liquid crystal screen, while the rest of backlight is mainly supplied by ambient light. Then, the rotation or rolling of the liquid crystal screen can determine whether the light can pass or be blocked, thereby making a user see a visual message. Through this transparent liquid crystal screen, users can look directly at the changes of the external environment when operating the display module 12. Thus not only the power consumption of the display module 12 is reduced to increase the endurance of the headphone device, but also the user may immediately respond to burst conditions of the external environment, as shown in FIG. 1A.

Furthermore, in the present invention the position of the rotary element 110 on the headset module is not limited, and an appropriate structure of the rotary element 110 could be designed by those skilled in the art according to an actual using condition. The structure is not limited in the present invention.

In addition, in the present invention the imaging mode of the display module 12 is not limited; for example, image information can be presented directly with real image on the display module 12, or with virtual image formed outside the display module 12. Of course, as described above, the display module 12 may be similarly set to have the function of a projector, thereby the image information is presented by projection or by projecting directly to the retina of the user, and the imaging mode is not limited in the present invention.

Please refer to FIG. 1B, which is a perspective schematic view showing one embodiment of a display module superimposed on a holder according to the present invention. As shown in FIG. 1B, the display module 12 of the headphone device 1 of the present invention has the feature of being arbitrarily rotated. When the display module 12 does not need to be used, the display module 12 can be rotated to the position of the holder 10, so that the display module 12 can be superimposed on the holder 10. In other words, the relative rotation between the display module 12 and the holder 10 can cause the display module 12 to be selectively superimposed on the holder 10. Furthermore, the rotation of the display module 12 in the present invention is not limited to manual trigger or automatic trigger, and those skilled in the art can directly design a corresponding structure according to actual using condition.

In addition, the display module 12 of the invention embodiment is pivoted only on a single headset module 11, so the user can only obtain image or text information of the electronic device 2 by a simple eye; however, those skilled in the art can design the display module 12 to be pivoted on the two headset module 11 so that the user can simultaneously obtain image or text information of the electronic device 2 by all eyes to increase visual effect.

It is worth noting that the transmission module 13 (not shown in FIG. 1A and 1B) of the headphone device 1 in the embodiment of the present invention FIG communicates with the electronic apparatus 2 for wireless transmission through a wireless communication protocol, such as Bluetooth protocol, Zigbee protocol, WiFi Agreement and IEEE 802.11 series of protocol, but the protocol is not limited thereto. However, in the present invention the signal transmission mode between the headphone device 1 and the electronic device 2 is not limited; for example, the transmission module 13 can be designed to be a physical line through which the headphone device 1 can execute signal transmission with the electronic device 2.

Furthermore, in order to well protect the display module 12, the holder 10 may be provided with a receiving pit, so that the display module 12 can be completely accommodated in the receiving pit when the display module 12 is superimposed on the holder 10.

### Another Embodiment of a Headphone Device

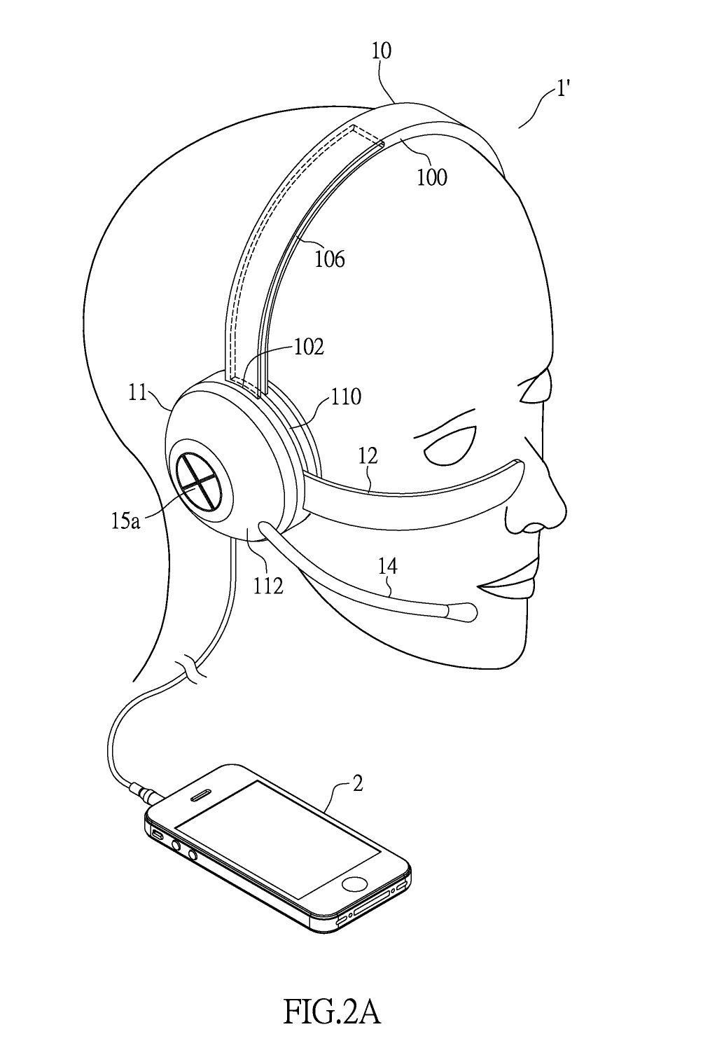

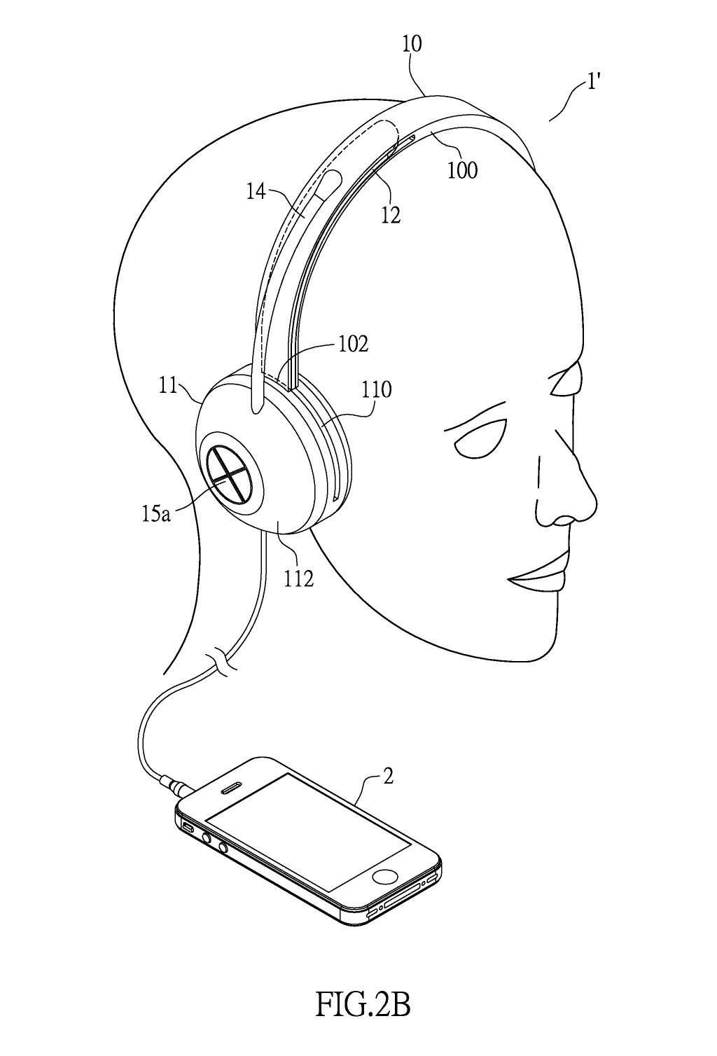

Please refer to FIG. 2A and 2B. FIG. 2A is a perspective schematic view showing another embodiment of a headphone device according to the present invention and FIG. 2B is a perspective schematic view showing a further embodiment of a display module superimposed on a holder according to the present invention. As showed in FIG. 2A and 2B, the headphone device 1′ executes signal transmission with electronic device 2 via physical lines. In addition, the headphone device 1′ is even provided with a receiving pit 106 and a set of microphone 14.

The receiving pit 106 is disposed on the holder 10, and the opening length and opening direction of the receiving pit 106 are corresponding to the shape of the display module 12 in order to accommodate the display module 12 into the receiving pit 106. However, in the present invention whether the headphone device 1′ is necessary to be provided with the receiving pit 106 is not limited; for instance, the display module 12 can be rotated and superimposed on the inside or the outside of the holder 10, so that the display module 12 can be overlapped with the holder 10.

As for the microphone 14 and the display module 12, they are same in that they are pivoted on the headset module 11, so that the microphone 14 can be rotated relative to the holder 10. In more detail, the display module 12 is pivoted on the earphone module 11 by means of the rotary element 110, and the microphone 14 is pivoted on the earphone module 11 by means of the rotary element 112, so that the display module 12 and the microphone 14 could be selectively rotated.

It is worth noting that the display module 12 and the microphone 14 of the headphone device 1′ may be in a mutually interlocking relationship, thus when the display module 12 is rotated with respect to the holder 10, the rotary element 110 will selectively drive the rotary member 112 to rotate, so that the microphone 14 will be rotated to a proper operation position or superimposed on the holder 10.

In addition, a plurality of buttons 15a can be set in the headphone device 1′, and the corresponding functions of the plurality of buttons 15a are volume control, screen color brightness control, screen resolution control, and subtitle size control etc, performed by fast keys or multimedia player control keys, but the functions are not limited thereto. For example, the corresponding function of a button 15a can be designed as a trigger switch, and therefore the display module 12 may be rotated out of the holder 10 or housed into the holder 10 when this button 15a is triggered, and the microphone 14 also can be simultaneously controlled by the button 15a or by another button, which is not limited in the present invention. Furthermore, in the present invention the setting positions of a plurality of buttons 15a described above are not limited, and said buttons 15a may be set on the outside of the headset module 11 or on the physical line.

On the other hand, although the display module 12 and the microphone 14 of a headphone device 1′ in this embodiment are set on the same side, so that when the display module 12 and the microphone 14 overlap on the holder 10, the display module 12 can be accommodated at the receiving pit 106, and the microphone 14 is superimposed on the holder 10 because of the space limitations of the receiving slot 106. However, the display module 12 and the microphone 14 can be set on different side, so that the display module 12 and the microphone 14 are respectively pivoted on the earphone module 11 at different side.

### A Further Embodiment of a Headphone Device

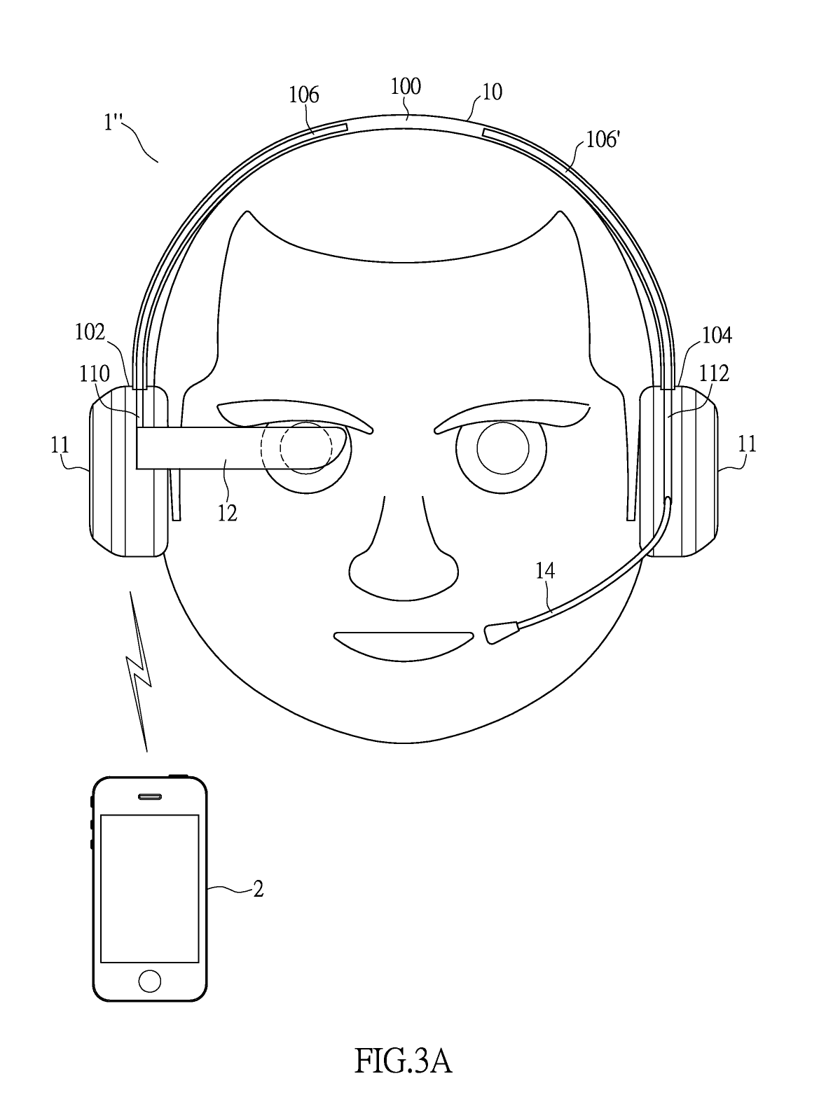

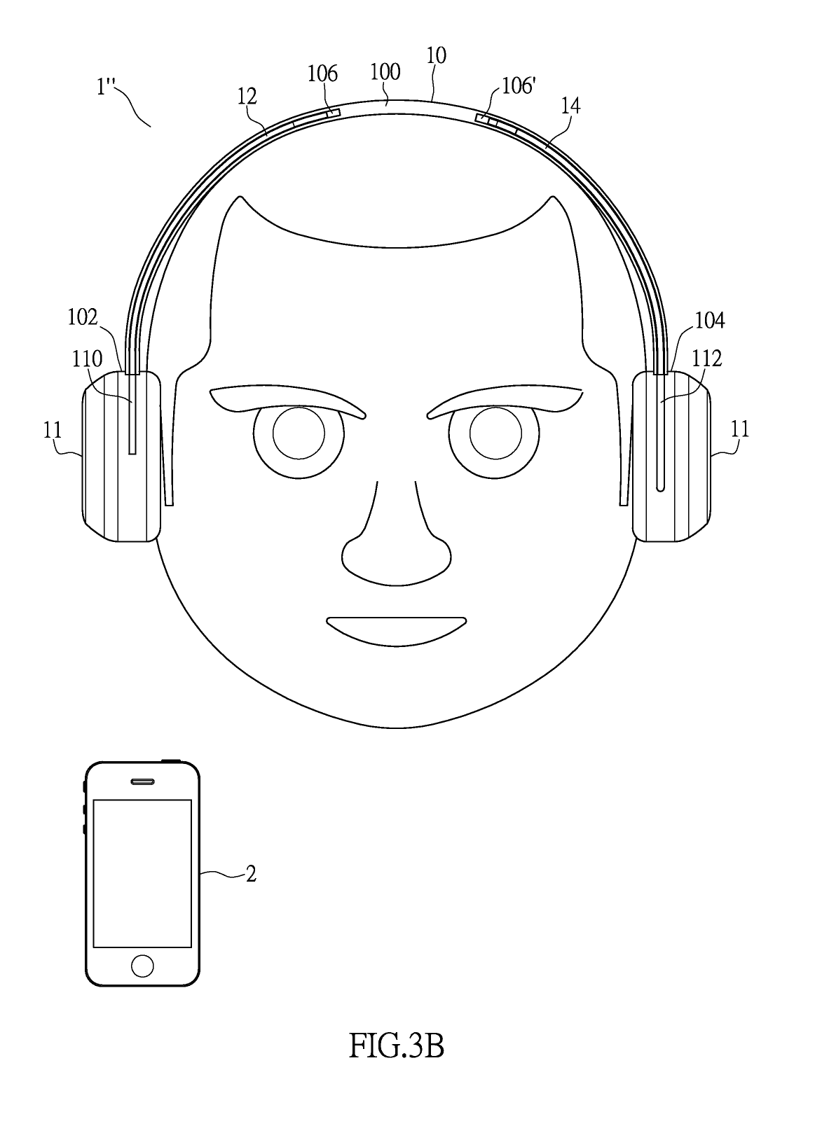

Please refer to FIG. 3A and 3B. FIG. 3A is a perspective schematic view showing a further embodiment of a headphone device according to the present invention, and FIG. 3B is a perspective schematic view showing a further embodiment of a display module superimposed on a holder according to the present invention. As showed in FIG. 3A and 3B, the display module 12 and the microphone 14 of the headphone device 1″ are pivoted on the headset module at different side, such that the display module 12 and the microphone 14 can be selectively accommodated in the receiving pit 106 and the receiving pit 106′ by means of the rotary element 110 and the rotary element 112, or rotated to a proper operation position.

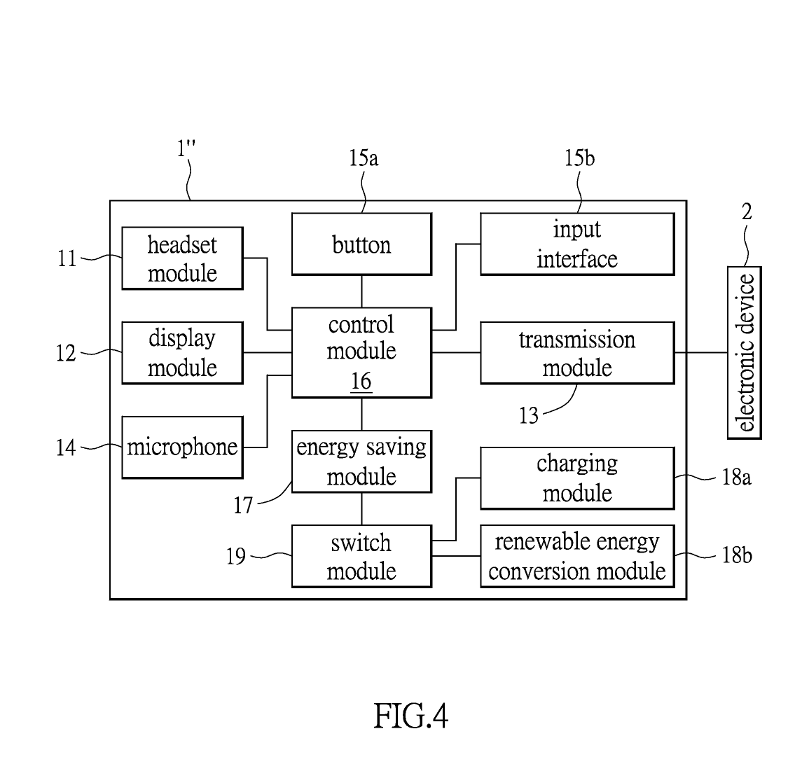

In order to more clearly illustrate the signal transmission and actuation relationship between the headphone device 1″ (or headphone device 1′) and the electronic device 2, please refer to FIG. 4, which is a block diagram showing a headphone device according to the present invention. As shown in FIG. 4, the headphone device 1″ includes the headset module 11, the display module 12, the transmission module 13, the microphone 14, the button 15a, the input interface 15b, the control module 16, the energy saving module 17, the charging module 18a, the renewable energy conversion module 18b, and the switch module 19, wherein the transmission module 13 is used for signal transmission with the electronic device 2, and the signal transmission is not limited to a wired transmission or a wireless transmission. Parts of the modules of the headphone module 1″ will not be depicted again because they have been described in previous embodiments.

The control module 16 is coupled with the headset module 11, the display module 12, the transmission module 13, the microphone 14, the button 15a, the input interface 15b, the control module 16, and the energy saving module 17, so that the control module 16 can, based on the using state of the electronic device 2, control the display module 12 and the microphone 14 to be rotated to proper operation positions or accommodated into the receiving pits 106 and 106′.

The input interface 15b controls the control module 16 to transmit an operating instruction to the electronic device 2, so that the electronic device 2 can perform the operation corresponding to the above operating instruction. Typically, this operating instruction includes that headphone device 1″ is instructed to receive at least one of information of sound, text and image from electronic device 2 and that electronic device 2 is instructed to transmit at least one of information of sound, text and image to another electronic device. In practice, the input interface 15b is a functional operation button or a functional operation wheel similar to the button 15a, whose functions comprise confirmation, cancel and selection but are not limited hereto. Those skilled in the art can design the corresponding operational function according to actual using demand.

In addition, those skilled in the art can even set the input interface 15b onto the display module 12 to form a touch display. Therefore, the user can control the electronic device 2 by touching the display module 12.

The energy saving module 17 is used to supply the electrical power for all modules of headphone device 1″. Typically, the energy saving module 17 is set in any one of the shell bodies of the headset modules 11, but is not limited hereto. In practice, the energy saving module 17 can be nickel-hydrogen batteries, lithium-ion batteries, nickel-chromium batteries, lithium polymer batteries or other equivalent storage batteries, which are not limited hereto in the present invention.

The charging module 18a is coupled with the energy saving module 17 through the switch module 19, and the charging module 18a receives an external power to charge the energy saving module 17. Generally, the charging module 18a is provided with AC-DC converter, so that the charging module 18a can be directly electrically connected to the city power supply socket in order to charge the energy saving module 17.

It is worth noting that, since the headphone device 1″ is provided with the display module 12,under a condition of normally deriving the display module 12 consumed power will be larger than that without the display module 12. In order to extend the time of supplying power to the energy saving module 17 of the headphone device 1″, the headphone device 1″ can be provided with another renewable energy conversion module 18b.

The renewable energy conversion module 18b is coupled with the energy saving module 17 through the switch module 19, and the renewable energy conversion module 18b is used for receiving the renewable energy (such as solar energy or wind power), and converting the renewable energy into a driving energy, then storing the driving energy into the energy saving module 17. In practice, the receiver of the renewable energy conversion module 18b is set at the outside of the shell body of the headset module 11 so as to efficaciously receive the energy provided by renewable energy sources; however, the receiver can also be set on the outside of the holder 10. The position of the receiver is not limited hereto in the present invention.

The switch module 19 is coupled with the energy saving module 17, the charging module 18a, and the renewable energy conversion module 18b, and the switch module 19 is used to choose external power source or renewable energy to charge the energy saving module 17. In other words, the switch module 19 selectively conducts either the first charging route passing from the charging module 18a to the energy saving module 17 or the second charging route passing from the renewable energy conversion module 18b to the energy saving module 17. Furthermore, a power detection module (not plotted in FIG. 4) could be disposed between the control module 16 and the energy saving module 17. When the power detection module detects power insufficiency in the energy saving module 17, a power detection signal will be sent to the control module 16, so that the control module 16 can control the switching of the switch module 19.

Besides, in order to more efficiently extend the using time of the headphone device 1″, the power supplied to the displayer module 12 and the microphone 14 may be turned off to enter into a sleep state when the displayer module 12 and the microphone 14 are respectively housed in the receiving pit 106 and 106′. The display module 12 and the microphone 14 can enter into an awakening state when rotated from the receiving pit 106 and 106′.

In more detail, when the display module 12 and the microphone 14 are respectively housed in the receiving pit 106 and the receiving pit 106′, or rotated to a special angle (e.g., the rotational angle from the horizontal plane is 30 degrees, 45 degrees or 60 degrees), the display module 12 and the microphone 14 will respectively produce a first sleep signal and a second sleep signal. When the control module 16 receives the first sleep signal from the display module 12 and the second sleep signal from the microphone 14, the control module 16 will instruct the energy saving module 17 to stop supplying power to the display module 12 and the microphone 14 in order to reduce unnecessary consumption of power. On the other hand, when the display module 12 and the microphone 14 are rotated out from the receiving pit 106 and the receiving pit 106′, and moved downwardly with a specific angle from the vertical plane (e.g., the downward rotation angle is 60 degrees, 45 degrees or 30 degrees), the display module 12 and the microphone 14 will respectively produce a first awakening signal and a second awakening signal. When he control module 16 receives the first awakening signal from the display module 12 and the second awakening signal from the microphone 14, the control module 16 will instruct the energy saving module 17 tore-supply power to the display module 12 and the microphone 14.

Take an actual operation as example. If the electronic device 2 is a smart phone and the headphone device 1″ has communicated with the electronic device 2, and when the electronic device 2 receives other person's phone call, the control module 16 of the headphone device 1″ will receive the trigger signal outputted from the electronic device 2, so that the control module 16 can control the display module 12 and the microphone 14 to be automatically rotated to proper positions according to this trigger signal, and at the same time the display module 12 and the microphone 14 will enter into an awakening state because of the first awakening signal and the second awakening signal. At this moment, the display module 12 will display counterpart's phone numbers and identity information. By this way, the user can, based on the contents of the display module 12, decide whether or not to listen this call through the input interface 15b.

Take another actual operation as example. When the display module 12 and the microphone 14 are housed in the receiving pit 106 and the receiving pit 106′ respectively, and when the user wants to dial a phone call, the display module 12 and the microphone 14 may be rotated to proper operation positions by triggering the button 15a or the input interface 15b, at this moment the display module 12 and the microphone 14 enter into an awakening state because of the first awakening signal and the second awakening signal. Then the user can search through the input interface 15b the saved address book or directly key-in the phone number, and the operating instructions including the above information is transmitted to the electronic device 2 by means of the control module 16, so as to make the electronic device 2 execute the operating instructions, and the user can use the headphone device 1″ to communicate with other persons by means of the communication connection between the electronic device 2 and the headphone device 1″. In addition, if the user wants to key-in a short message, the user can directly key-in a text message through the input interface 15b, or the user's voice is converted to text information by means of the microphone 14 and the control module 16. The mode for keying-in a short message is not limited in the present invention.

Take further another actual operation as example. If the headphone device 1″ is playing multimedia files stored in the electronic device 2 (for example, the user is listening to music), the position of the display module 12 is determined based on user's using habit. If the display module 12 is at the operation position, the sound information (such as lyrics, singer and sound volume messages) that is playing will be displayed. When finishing playing music, the display module 12 will be rotated to a proper operation position immediately, and display a list of all multimedia files in the electronic device 2, in order for the users to choose. Similarly, if the user is using the headphone device 1″ to play a video, its operation principle is similar to the above and will not be described again.

Continuously with the above, when the headphone device 1″ plays multimedia files such as music or video films, the microphone 14 needs not be used, thus the microphone 14 would be under a sleep state to reduce unnecessary consumption of electrical energy. Therefore, the present invention does not limit relative relationship of rotation between the display module 12 and the microphone 14, and those skilled in the art can design a rational linkage condition according to actual using condition.

In addition, the headphone device 1″ of the present invention may be even provided with a camera whose photographing angle can arbitrarily be adjusted to attain the function of recording the peripheral environment or performing a video conversation with other persons. Besides, the headphone device 1″ of the present invention can be provided with a set of action sensor, and the user can use the combined action of nodding the head and shaking the hand to operate the electrical device 2.

Furthermore, the display module 12 of the headphone device 1″ of the present invention can be even provided with a layer of full sight-line dimming discolored film, which can, based on the strength of ultraviolet light, automatically adjust the color depth, thereby reducing the fatigue and discomfort of the eyes caused by strong light. The setting method of the dimming discolored film may be, for example, a hot-melt technique or coating technology, and is not limited in the present invention.

### Efficacy of the Embodiments

In summary, the embodiments of the present invention provide a design of a headphone device, and the display module and the microphone of the headphone device are pivoted on the headset module, so that the display module and the microphone can be relatively or independently rotated to the holder. Thus, when the user do not need to use the display module and microphone, the user can let the display module and the microphone be superimposed on the holder, and the display module and the microphone enter into a sleep state. When it is necessary to use the display module and the microphone, the user can rotate the display module and the microphone to proper operation positions, and let the display module and the microphone enter into an awakening state, thus the flexibility in the practical use is increased and unnecessary power consumption is reduced. In addition, since the headphone device of the present invention can be used with an electronic device to form a wireless communication connection and a design of the input interface, it is very practical that the electronic device can be directly operated through the headphone device.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A headphone device adapted to transmit a signal with an electronic device, the headphone device comprising:
a holder;
a headset module disposed on at least one end of said holder; and
a display module pivoted on said headset module such that said display module is rotatable with respect to said holder;
wherein a relative rotation between said display module and said holder enables said display module to be selectively superimposed on said holder.

2. The headphone device according to claim 1, wherein said headphone device further comprises a microphone pivoted on said headset module, so that said microphone rotates with respect to said holder.

3. The headphone device according to claim 2, wherein when said display module rotates with respect to said holder, said display module enables the rotation of said microphone.

4. The headphone device according to claim 1, wherein said holder further has a receiving pit for accommodating said display module.

5. The headphone device according to claim 1, wherein said headphone device further comprises a button, and when said button is triggered, said display module is rotated out from said holder or superimposed on said holder.

6. The headphone device according to claim 1, wherein said headphone device further comprises a control module, said control module is coupled with said headset module and said display module, and controls said display module to be rotated out from said holder or superimposed on said holder according to the using state of said electronic device.

7. The headphone device according to claim 6, wherein said headphone device further comprises an input interface, said input interface is coupled with said control module in order to control said control module to send an operating instruction to said electronic module, thereby said electronic module executes a corresponding operation.

8. The headphone device according to claim 7, wherein said input interface is set at said display module, and controls the operation of said electronic device by touching said display module.

9. The headphone device according to claim 1, wherein when said display module is superimposed on said holder, said display module enters into a sleep state; when said display module is rotated out from said holder, said display module enters into an awakening state.

10. The headphone device according to claim 1, wherein said headphone device further comprises:
a saving energy module providing electrical energy for said headphone device;
a charging module coupled with said saving energy module, for receiving an external power source to charge said saving energy module;
a renewable energy conversion module coupled with said saving energy module, for receiving a renewable energy to form a driving power source, and saving said driving power source into said saving energy module; and
a switch module coupled with said saving energy module, said charging module, and said renewable energy conversion module, thereby said external power source or said renewable energy conversion module is chosen to charge said saving energy module.
